(19) United States
(12) Patent Application Publication
(10) Pub. No.: US 2024/0338720 A1
(43) Pub. Date: Oct. 10, 2024

(54) METHODS FOR PRODUCING A FRAGRANCE COMPOSITION THAT ELICITS AN EMOTIONAL OR COGNITIVE RESPONSE AND COMPOSITIONS THEREOF

(71) Applicant: INTERNATIONAL FLAVORS & FRAGRANCES INC., Union Beach, NJ (US)

(72) Inventors: Camille Pouy, Asnières sur Seine (FR); Serigne Fallou Mbaye, Neuilly-sur-Seine (FR); Khaled Nasroune, Asnières sur Seine (FR)

(21) Appl. No.: 18/716,334

(22) PCT Filed: Dec. 7, 2022
(86) PCT No.: PCT/US2022/052145

§ 371 Date: Jun. 4, 2024

Related U.S. Application Data
(60) Provisional application No. 63/286,770, filed on Dec. 7, 2021.

(51) Int. Cl. G06Q 30/0204; C11D 3/50

(52) U.S. Cl. CPC G06Q 30/0204; C11D 3/50

(57) ABSTRACT

Provided herein are methods for producing fragrance compositions, e.g., fully formulated fragrances or accords, that elicit an emotional and/or cognitive response in a subject from exposure to the fragrance composition. Also provided are fragrance compositions formulated according to such methods and consumer products containing such fragrance compositions.

### CROSS-REFERENCE TO RELATED APPLICATION

This application claims priority from U.S. provisional application No. 63/286,770, filed Dec. 7, 2021, the contents of which are hereby incorporated by reference in their entirety.

### FIELD OF THE INVENTION

Provided herein are methods for producing fragrance compositions, e.g., fully formulated fragrances or accords, that elicit an emotional and/or cognitive response in a subject from exposure to the fragrance composition. Also provided are fragrance compositions formulated according to such methods and consumer products containing such fragrance compositions.

### BACKGROUND OF THE INVENTION

The ability of odor to impact a subject, such as a human subject, psychologically is widely recognized, and there exists both market and consumer interest in using fragrance compositions for purposes of explicitly driving emotional and/or cognitive responses. However, formulating fragrance compositions capable of eliciting desired mental responses in a subject has remained challenging at least in part due to the vast number of available fragrance ingredients, a problem which is compounded when considering potential interactions between fragrance ingredients. In addition, differences in olfactory preferences among demographic groups can hinder the creation of a fragrance composition that universally or selectively elicits particular emotional and/or cognitive responses. While consumer research techniques can be useful to assess subjects' mental responses to a fragrance, e.g., an emotional or cognitive response to fragrance exposure, used in isolation these techniques may fail to provide guidance for the production of fragrance compositions that reliably elicit mental responses both within and across demographic groups.

Thus, there exists a need for methods for producing fragrance compositions capable of eliciting emotional and/or cognitive responses both within and across demographic groups, and compositions formulated according to such methods. The methods and composition provided herein address these and other needs in the art.

### SUMMARY OF THE INVENTION

In an aspect is provided a method for producing a fragrance composition that elicits an emotional and/or cognitive response in a subject, the method including: (a) selecting one or more target emotional and/or cognitive responses to be elicited by a fragrance composition; (b) identifying in a plurality of association rules one or more fragrance ingredients and/or one or more combinations of fragrance ingredients that elicit the one or more target emotional and/or cognitive responses, wherein each association rule corresponds to a fragrance ingredient concentration or a combination of fragrance ingredient concentrations that elicits an emotional and/or cognitive response in a subject; and (c) formulating into the fragrance composition the one or more fragrance ingredients and/or one or more combinations of fragrance ingredients at concentrations that elicit the one or more target emotional and/or cognitive responses. In some embodiments, the plurality of association rules are generated by: (a) identifying in a plurality of fragrance datasets a frequent fragrance ingredient concentration and/or frequent co-occurring fragrance ingredient concentrations, wherein each of the plurality of fragrance datasets includes an emotional and/or cognitive response elicited in a subject from an exposure to a fragrance and a concentration for each of one or more fragrance ingredients included in the fragrance; and (b) determining based on the frequent fragrance ingredient concentration and/or the frequent co-occurring fragrance ingredient concentrations the plurality of association rules. In some embodiments, the fragrance composition that elicits the one or more target emotional and/or cognitive responses is applicable to a global population. In some embodiments, the fragrance composition that elicits the one or more target emotional and/or cognitive responses is applicable to a demographic group. In some embodiments, the fragrance composition is a new fragrance composition. In some embodiments, the fragrance composition is an existing fragrance composition. In some embodiments, the fragrance composition is an existing fragrance composition that has been modified. In some embodiments, the fragrance composition is an existing fragrance composition that has been modified by adding a new fragrance ingredient, removing an existing fragrance ingredient, increasing a concentration of an existing fragrance ingredient, decreasing a concentration of an existing fragrance ingredient, or any combination thereof. In some embodiments, the fragrance composition is a fully formulated fragrance or an accord. In some embodiments, the fragrance composition is included in a consumer product. In some embodiments, the consumer product is a household product, a laundry product, a personal care product, a cosmetic product, or a fine fragrance. In some embodiments, the consumer product is a household product, a fabric care product, a personal care product, a cosmetic product, or a fine fragrance. In some embodiments, the fragrance composition elicits an emotional and/or cognitive response that is correlated with the one or more target emotional and/or cognitive responses.

In an aspect is provided a method for identifying a fragrance ingredient and/or a combination of fragrance ingredients that elicit an emotional and/or cognitive response in a subject, including: (a) identifying in a plurality of fragrance datasets a frequent fragrance ingredient concentration and/or frequent co-occurring fragrance ingredient concentrations, wherein each of the plurality of fragrance datasets includes an emotional and/or cognitive response elicited in a subject from an exposure to a fragrance and a concentration for each of one or more fragrance ingredients included in the fragrance; and (b) determining one or more association rules based on the frequent fragrance ingredient concentration and/or the frequent co-occurring fragrance ingredient concentrations, wherein each association rule corresponds to a fragrance ingredient concentration or combination of fragrance ingredient concentrations that elicits the emotional and/or cognitive response.

In some embodiments, the plurality of fragrance datasets is produced by performing consumer testing or receiving consumer testing data. In some embodiments, the emotional and/or cognitive response elicited in the subject is determined using a declarative test and/or a physiological-based test. In some embodiments, the emotional and/or cognitive response is selected from the group consisting of caring, clean, energizing, feminine, fresh, happy, natural, relaxing, sensual, sophisticated, attention, self-esteem, mindfulness, memory, happiness, relaxation, seduction, energy, a color, healthy, soft, memorable, “it provides simple cleaning,” “it cleans very effectively,” “it fights and prevents malodors,” “it provides a soft cleaning,” “it has sanitizing properties,” “it provides reassuring freshness,” “it facilitates the cleaning process,” “it boosts my energy,” “it provides protection,” “it is harmless and good for my health,” “it nourishes and moisturizes,” “it takes care of me and helps me to unwind,” “it helps me to look beautiful,” “it helps me to feel beautiful,” “it is authentic, like the real thing,” “it is unique and upscale,” “it enhances my mood and makes me feel good,” “it makes me feel good,” “it delights my senses,” “it transports me to a place I love,” “it connects me with nature,” “it helps me feel well groomed,” “I like it,” it helps me feel unique and stand out,” “it helps me to look sophisticated and seductive,” “it makes me sensual and feminine,” “it makes me feel fresh and in a good mood,” “a tasteful mark of respect that pleases others,” “it enhances my femininity and makes me feel more self-confident,” “it makes me feel charming, seductive, and elegant,” “it makes me feel sexy, attractive, and appealing,” “it calls attention,” “it makes me feel good and in a better mood,” “it makes me feel comfortable, safe, and reassured,” and “it makes me feel fresh and clean.” In some embodiments, the one or more target emotional and/or the cognitive responses are selected from the group consisting of caring, clean, energizing, feminine, fresh, happy, natural, relaxing, sensual, sophisticated, attention, self-esteem, mindfulness, memory, happiness, relaxation, seduction, energy, a color, healthy, soft, —memorable, “it provides simple cleaning,” “it cleans very effectively,” “it fights and prevents malodors,” “it provides a soft cleaning,” “it has sanitizing properties,” “it provides reassuring freshness,” “it facilitates the cleaning process,” “it boosts my energy,” “it provides protection,” “it is harmless and good for my health,” “it nourishes and moisturizes,” “it takes care of me and helps me to unwind,” “it helps me to look beautiful,” “it helps me to feel beautiful,” “it is authentic, like the real thing,” “it is unique and upscale,” “it enhances my mood and makes me feel good,” “it makes me feel good,” “it delights my senses,” “it transports me to a place I love,” “it connects me with nature,” “it helps me feel well groomed,” “I like it,” it helps me feel unique and stand out,” “it helps me to look sophisticated and seductive,” “it makes me sensual and feminine,” “it makes me feel fresh and in a good mood,” “a tasteful mark of respect that pleases others,” “it enhances my femininity and makes me feel more self-confident,” “it makes me feel charming, seductive, and elegant,” “it makes me feel sexy, attractive, and appealing,” “it calls attention,” “it makes me feel good and in a better mood,” “it makes me feel comfortable, safe, and reassured,” and “it makes me feel fresh and clean.” In some embodiments, the fragrance is a fragrance ingredient, an accord, a schema, or a fully formulated fragrance. In some embodiments, the frequent fragrance ingredient concentration and/or frequent co-occurring fragrance ingredient concentrations satisfy a minimum level of support of at least 5%. In some embodiments, each of the association rules satisfies a minimum level of lift of at least 1.1. In some embodiments, the level of lift is robust according to a non-parametric test. In some embodiments, the non-parametric test is a permutation test. In some embodiments, the fragrance ingredient concentration and/or the combination of fragrance ingredient concentrations of the association rule is expressed as a concentration range and/or an average concentration for the fragrance ingredient or each of the fragrance ingredients in the combination, and wherein a lower bound and an upper bound of the concentration range are determined by identifying a lower most concentration and an upper most concentration of the fragrance ingredient or each of the fragrance ingredients in the combination that elicits the emotional and/or cognitive response. In some embodiments, the combination of fragrance ingredient concentrations of the association rule is expressed as a range of ratios of the fragrance ingredients in the combination and/or an average ratio of the fragrance ingredients in the combination, and wherein a lower bound and an upper bound of the ratio range are determined by identifying a lower most concentration and an upper most concentration of each of the fragrance ingredients in the combination that elicits the emotional response or cognitive response. In some embodiments, each of the association rules are applicable to a global population. In some embodiments, each of the association rules are applicable to a demographic group. In some embodiments, each of the association rules are stored in a database.

In an aspect is provided a database including a plurality of association rules determined according to the methods described herein.

In an aspect is provided a fragrance ingredient, a fragrance ingredient combination, a fully formulated fragrance, or an accord that elicits one or more emotional and/or cognitive responses in a subject, wherein the fragrance ingredient, the fragrance ingredient combination, the fully formulated fragrance, or the accord includes one or more fragrance ingredients or one or more combinations of fragrance ingredients determined according to the methods described herein or the database described herein to elicit the emotional or cognitive response.

In an aspect is provided a method for preparing a fully formulated fragrance or an accord that elicits an emotional and/or cognitive response, the method including: (a) identifying according to a method described herein or a database described herein a fragrance ingredient or fragrance ingredient combination that elicits a target emotional and/or cognitive response; and (b) formulating into a fully formulated fragrance or an accord the fragrance ingredient or fragrance ingredient combination at concentrations that elicit the target emotional and/or cognitive response.

In an aspect is provided a consumer product including a fragrance composition produced according to a method described herein, a fragrance ingredient, a fragrance ingredient combination, a fully formulated fragrance, or an accord that elicits an emotional and/or cognitive response as, or a fully formulated fragrance or an accord prepared according to a method described herein, wherein the consumer product is a household product, a laundry product, a personal care product, a cosmetic product, or a fine fragrance. In an aspect is provided a consumer product including a fragrance composition produced according to a method described herein, a fragrance ingredient, a fragrance ingredient combination, a fully formulated fragrance, or an accord that elicits an emotional and/or cognitive response as, or a fully formulated fragrance or an accord prepared according to a method described herein, wherein the consumer product is a household product, a fabric care product, a personal care product, a cosmetic product, or a fine fragrance.

In an aspect is provided use of a fragrance composition produced according to a method described herein, a fragrance ingredient, a fragrance ingredient combination, a fully formulated fragrance, an accord that elicits an emotional and/or cognitive response as described herein, or a fully formulated fragrance or an accord prepared according to a method described herein, or a consumer product described herein to elicit one or more emotional and/or cognitive responses in a consumer from exposure.

Each of the aspects and embodiments described herein are capable of being used together, unless excluded either explicitly or clearly from the context of the embodiment or aspect.

### BRIEF DESCRIPTION OF THE DRAWINGS

FIGS. 1 and 2 are flow diagrams illustrating exemplary methods of identifying fragrance ingredient combinations that elicit an emotional and/or cognitive response.

FIG. 3 shows a schematic illustration of an exemplary system for performing a method described herein.

### DETAILED DESCRIPTION OF THE INVENTION

The mammalian olfactory pathway is an evolutionarily old pathway that differs from canonical thalamocortical sensory pathways in that it forms direct and, in some cases, reciprocal connections with brain structures involved in emotion and memory. For example, olfactory sensory neurons present in the nose convey sensory information to the olfactory bulb, located in the forebrain, where they form synapses with projection neurons that directly or indirectly target limbic system structures, including the hippocampus and amygdala which are related to memory and emotion. Thus, the sense of smell is uniquely positioned neuroanatomically to quickly and directly impact a subject's emotional and cognitive state.

Individuals and businesses alike have for decades explored ways of using fragrances to drive specific emotional or cognitive responses in subjects, and there remains a consumer interest in products capable of delivering such results. However, the production of fragrance compositions that reliably elicit an emotional and/or cognitive response in a subject is not a straightforward task. The total number of fragrance ingredients; fragrance ingredient combinations; and concentrations of fragrance ingredients, either alone or in combination, represents an exceptionally large olfactory space for consumer testing. Thus, data collected from consumer tests can be both large and non-uniform (e.g., fragrances tested and/or the concentrations of fragrances tested differ across consumer tests), which can hinder the derivation of meaningful information from broad consumer testing. Furthermore, olfactory preferences may differ across demographics, meaning that even if a comprehensive test of the vast sample space was conducted in a population of subjects, the results could fail to capture population-specific response differences and/or global level trends. There is thus a need for a practical approach to identifying fragrance ingredients and combinations thereof that reliably elicit emotional and/or cognitive responses at population-specific and global levels that could serve as a basis for producing fragrance compositions that elicit a desired emotional and/or cognitive response. An emotional and/or cognitive response may alternatively be referred herein to as a mental response. Similarly, an emotional and/or cognitive state may alternatively be referred to herein as a mental state.

As described herein (see, e.g., Examples), it was surprisingly found that performing a method of association rule mining described herein on data collected from consumer testing could identify fragrance ingredients and combinations of fragrance ingredients at specific concentrations that elicited emotional and/or cognitive responses, and when formulated into a fragrance composition elicited the emotional and/or cognitive response in a subject upon exposure to the fragrance composition. In addition, the association rule mining method could be used to identify concentrations of fragrance ingredients and concentrations of fragrance ingredients in combination that elicited emotional and/or cognitive responses that were demographic-specific (e.g., country-specific) or generalizable. Thus, the methods described herein can be used to elucidate fragrance ingredients and combinations thereof that elicit emotional and/or cognitive responses independent of demographic factors (e.g., are globally applicable) as well as fragrance ingredient combinations that are applicable to specific demographic groups (demographic-specific). The methods and compositions described herein harness these findings to provide methods for producing fragrance compositions that elicit an emotional and/or cognitive response in a subject, and fragrance compositions formulated in accordance with such methods.

Provided herein are methods for producing a fragrance composition that elicits an emotional and/or cognitive response in a subject from exposure to the fragrance composition. In some embodiments, the methods include identifying fragrance ingredients and/or combinations of fragrance ingredients that elicit an emotional and/or cognitive response, for example emotional and/or cognitive responses as described in Section I-A, in a subject. In some embodiments, the methods for identifying fragrance ingredients and/or combinations of fragrance ingredients that elicit an emotional and/or cognitive response include association rule mining. At a general level, association rule mining is a rule-based machine learning method for identifying relationships, e.g., correlations, between variables (e.g., items) in datasets. As applied herein, association rule mining may be used to determine fragrance ingredients and combinations thereof that elicit a mental response in a subject by mining consumer test data, e.g., fragrance datasets as described in Section I-A, to produce association rules. An association rule generated by the methods provided herein may be a fragrance ingredient concentration or a combination of fragrance ingredients at specific concentrations that elicit an emotional and/or cognitive response in a subject. These rules can in turn be used to develop new fragrance compositions or modify existing fragrance compositions to elicit one or more desired mental responses. The methods provided herein are advantageous in that they allow the identification of concentration ranges for individual fragrance ingredients and concentration ranges for each fragrance ingredient in a combination of fragrance ingredients that elicit a mental response. The methods allow identification of such concentration ranges from data acquired from consumer testing using fragrances with known concentrations of ingredients, without the need to test each concentration in the range. Thus, the methods provided herein have an advantage in that they circumvent the need to test many concentrations and combination of concentrations of fragrance ingredients to determine a range of concentrations for ingredients or combinations of ingredients that elicit an emotional and/or cognitive response.

Association rules generated according to the methods herein may be collected in a database. In some embodiments, the database is searchable, e.g., by querying. In some embodiments, the database may include a user interface to facilitate searching (querying) and data extraction. In some embodiments, the database may be queried to identify association rules useful for formulating a fragrance composition, optionally an existing or new composition, that elicits one or more desired emotional and/or cognitive responses in a subject. A desired emotional and/or cognitive response may also be referred to herein alternatively as a target emotional and/or cognitive response. In some embodiments, the database may be used to predict a consumer's emotional and/or cognitive response to a fragrance composition, e.g., an existing fragrance composition or new composition, without the need to perform a consumer test. For example, the emotional and/or cognitive response may be predicted based on the fragrance ingredients of the fragrance composition in view of the association rules.

Also provided herein are compositions, such as a fragrance ingredient and fragrance ingredient combinations that elicit an emotional and/or cognitive response in a subject. Fully formulated fragrances, accords, and consumer products containing a fragrance ingredient and/or a fragrance ingredient combination that elicits an emotional and/or cognitive response in a subject are also provided. The composition may be specifically formulated to elicit one or more emotional and/or cognitive responses.

The methods and compositions described herein are advantageous in that they can be used to determine useful and reliable information from consumer test data, which can improve the production speed, efficiency, and reliability of fragrance compositions produced for purposes of eliciting a desired mental response. The methods described herein allow for the creation of fragrance formulation guidelines for producing a fragrance composition that elicits a target emotional and/or cognitive response in a subject.

This disclosure is not limited by the exemplary methods and materials disclosed herein, and any methods and materials similar or equivalent to those described herein can be used in the practice or testing of embodiments of this disclosure.

The headings provided herein are not limitations of the various aspects or embodiments of this disclosure which can be had by reference to the specification as a whole. The section headings used herein are for organizational purposes only and are not to be construed as limiting the subject matter described. Any terms defined are more fully defined by reference to the specification as a whole.

All publications, including patent documents, scientific articles and databases, referred to in this application are incorporated by reference in their entirety for all purposes to the same extent as if each individual publication were individually incorporated by reference. Nothing herein is to be construed as an admission that such publications constitute prior art. If a definition set forth herein is contrary to or otherwise inconsistent with a definition set forth in the patents, applications, published applications and other publications that are herein incorporated by reference, the definition set forth herein prevails over the definition that is incorporated herein by reference.

### Definitions

Definitions of terms may appear throughout the specification. It is to be understood that this disclosure is not limited to particular embodiments described, as such may, of course, vary. It is also to be understood that the terminology used herein is for the purpose of describing particular embodiments only and is not intended to be limiting.

Unless defined otherwise, all technical and scientific terms used herein have the same meaning as commonly understood by one of ordinary skill in the art to which this disclosure belongs.

It must be noted that as used herein and in the appended claims, the singular forms “a”, “an”, and “the” include plural referents unless the context clearly dictates otherwise. For example, “a” or “an” include “at least one” and “one or more.”

The terms “comprising”, “comprises” and “comprised of” as used herein are synonymous with “including”, “includes” or “containing”, “contains”, and grammatical variants thereof, are inclusive or open-ended and do not exclude additional, non-recited members, elements or method steps.

The terms “comprising”, “comprises” and “comprised of”, “including”, “includes” or “containing”, “contains”, and grammatical variants thereof also include the term “consisting of”.

“Optional” or “optionally” means that the subsequently described event or circumstance may or may not occur, and that the description includes instances where said event or circumstance occurs and instances where it does not.

The terms “fragrance composition,” “fragrance formulation,” “perfume composition,” and variants, including grammatical variants, thereof mean the same and refer to a composition that is a mixture of fragrance ingredients including, for example, alcohols, aldehydes, ketones, esters, ethers, lactones, nitriles, natural oils, synthetic oils, mercaptans, etc., which are admixed so that the combined odors of the individual ingredients produce a fragrance.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

Values and ranges may be presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context. All values and ranges may implicitly include the term “about” unless the context dictates otherwise.

### I. METHODS FOR PRODUCING A FRAGRANCE COMPOSITION THAT ELICITS AN EMOTIONAL AND/OR COGNITIVE RESPONSE

The methods provided herein are useful for producing a fragrance composition that elicits an emotional and/or cognitive response in a subject upon olfactory exposure to the fragrance composition. In some embodiments, the subject is a human. In some embodiments, the methods include the use of association rule mining techniques for the identification of fragrance ingredients and combinations of fragrance ingredients that elicit an emotional and/or cognitive response. The relationships determined by the association rule mining techniques may be used to develop new fragrance compositions or modify existing fragrance compositions to achieve a desired (target) mental response.

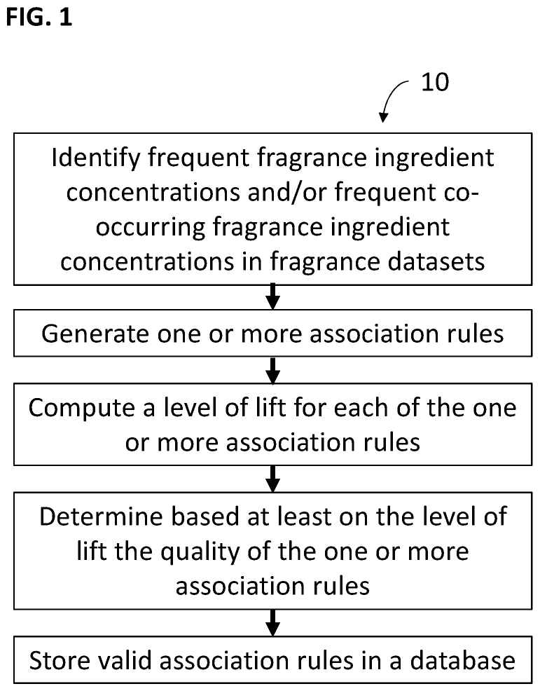

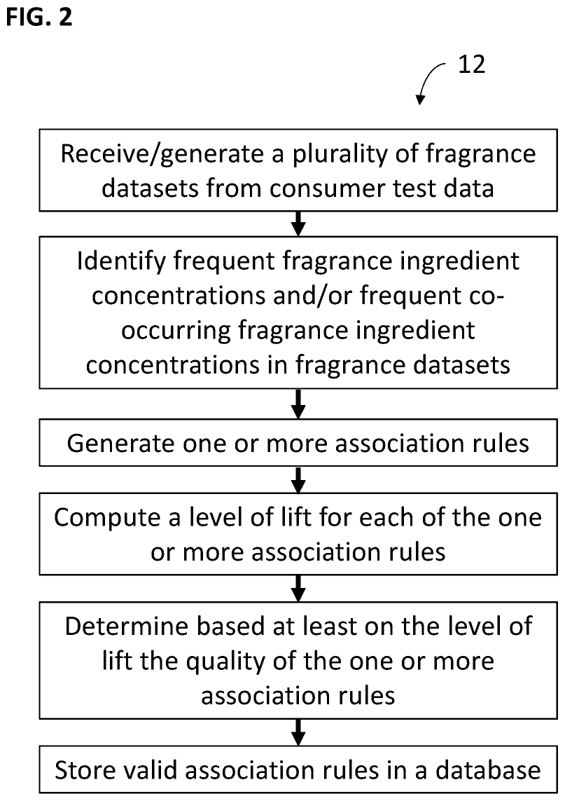

Association rule mining techniques typically employ a two-part process in which frequent items in a collection of items are first identified and association rules are generated from the frequent items. Association rules may be evaluated for quality to ensure that the rules are reliable. An association rule that satisfies a quality evaluation may be referred to herein as a valid association rule. FIGS. 1 and 2 illustrate exemplary embodiments of association rule mining methods provided herein.

In some embodiments, the association rule mining method mines consumer test data which may be present in the form of fragrance datasets, e.g., as described in Section I-A. In some embodiments, the method includes identifying a frequent fragrance ingredient concentration in the fragrance datasets. In some embodiments, the method includes identifying frequent co-occurring fragrance ingredient concentrations in the fragrance datasets. In some embodiments, the frequent co-occurring fragrance ingredient concentrations includes any number of fragrance ingredients. In some embodiments, the frequent co-occurring fragrance ingredient concentrations includes two or more fragrance ingredients. In some embodiments, the frequent co-occurring fragrance ingredient concentrations includes three or more fragrance ingredients. In some embodiments, the frequent co-occurring fragrance ingredient concentrations includes 2, 3, 4, 5, 6, 7, 8, 9, or 10 fragrance ingredients. In some embodiments, the method includes identifying a frequent fragrance ingredient concentration and/or frequent co-occurring fragrance ingredient concentrations in the fragrance datasets. Methods of identifying frequent items in a collection of items are generally known in the art and include, but are not limited to, an Apriori algorithm, an Eclat algorithm, a frequent pattern (FP)-growth algorithm, and the like. In some embodiments, the identification of a frequent co-occurring fragrance ingredient concentrations may be determined by identifying all frequent lower dimensional subsets. By way of example, to identify all frequent 2-dimensional sets of items (sets of items, including 1-dimensional sets of items, may also be referred to herein as an itemset), all frequent 1-dimensional itemsets may be determined first, and based on the frequent 1-dimensional itemsets, frequent 2-dimensional itemsets can be identified. In some embodiments, the determination of frequent itemsets includes satisfaction of a minimum level of support (see, Section I-B-1). In some embodiments, the frequent fragrance ingredient concentration and the frequent co-occurring fragrance ingredient concentrations are identified according to a minimum level of support as described in Section I-B-1.

From the identified frequent fragrance ingredient concentrations and/or the identified frequent co-occurring fragrance ingredient concentrations, one or more or a plurality of association rules may be generated. In some embodiments, an association rule corresponds to a concentration of a fragrance ingredient that elicits an emotional and/or cognitive response. In some embodiments, an association rule corresponds to a combination of fragrance ingredients at particular concentrations that elicits an emotional and/or cognitive response. In some embodiments, the one or more or plurality of association rules include association rules corresponding to a concentration of a fragrance ingredient that elicits an emotional and/or cognitive response. In some embodiments, the one or more or plurality of association rules include association rules corresponding to a combination of fragrance ingredients at particular concentrations that elicits an emotional and/or cognitive response. In some embodiments, the one or more or plurality of association rules include association rules corresponding to a concentration of a fragrance ingredient that elicits an emotional and/or cognitive response and association rules corresponding to a combination of fragrance ingredients at particular concentrations that elicits an emotional and/or cognitive response. Individual association rules may include either a concentration of a fragrance ingredient or a combination of fragrance ingredients at particular concentrations that elicits one emotional or cognitive response. However, it should be appreciated that a fragrance composed of one or more fragrance ingredients may elicit one or more emotional and/or cognitive responses in a subject. Thus, in some embodiments, an identical concentration of a fragrance ingredient may result in one or more association rules, where each rule relates the concentration of the fragrance ingredient to one emotional or cognitive response that is different from every other rule. Likewise, an identical combination of fragrance ingredients at particular concentrations may result in one or more association rules, where each rule relates the combination to one emotional or cognitive response that is different from every other rule. In some embodiments, a single fragrance ingredient may be included in a fragrance composition, e.g., an existing or a new fragrance composition, to elicit two or more emotional and/or cognitive responses. In some embodiments, a single fragrance ingredient combination may be included in a fragrance composition, e.g., existing or new fragrance composition, to elicit two or more emotional and/or cognitive responses. In some embodiments, a fragrance composition may contain more than one fragrance ingredient and/or more than one combination of fragrance ingredients to elicit a single emotional or cognitive response. Thus, the fragrance compositions described herein may include one or more association rules. For example, the fragrance composition may include one or more fragrance ingredients and/or one or more fragrance ingredient combinations at concentrations that elicit an emotional and/or cognitive response. In some embodiments, the fragrance composition includes one or more association rules that elicit the same emotional and/or cognitive response. In some embodiments, the fragrance composition includes one or more association rules that each elicit different emotional and/or cognitive responses.

Depending on the method for identifying frequent itemsets, it is possible to generate a large number of association rules. For example, if frequent n-dimensional co-occurring fragrance ingredient concentrations are determined by first identifying all frequent 1-dimensional fragrance ingredient concentrations, a large number of association rules may be produced to capture small differences in concentration combinations for the same fragrance ingredients that when combined elicit the same mental response. The same abundance of association rules is also possible when assessing frequent 1-dimensional itemsets. Although having this level of granularity may be useful, it may also be advantageous to consolidate the rules into a range of concentrations of the fragrance ingredients that elicit an emotional and/or cognitive response. Thus, in some embodiments, a concentration range for the fragrance ingredient and/or each fragrance ingredient in a combination of fragrance ingredients is determined. In some embodiments, the concentration range for the fragrance ingredient includes a lower bound equal to the minimum concentration of the fragrance ingredient present in a consumer tested fragrance and an upper bound equal to the maximum concentration of the fragrance ingredient present in a consumer tested fragrance. In some embodiments, the lower and upper bounds are determined by identifying the lower most and upper most concentrations of the fragrance ingredient that elicit the same emotional and/or cognitive response. In some embodiments, for example when considering a combination of fragrance ingredients, the lower and upper bounds are determined by identifying the lower most and upper most concentrations of each fragrance ingredient when present in the combination that elicits the same emotional and/or cognitive response. In some embodiments, the lower most and upper most concentrations of the fragrance ingredient that elicit the response are determined by quantifying a level of lift, for example as defined in Section I-B-3. In some embodiments, the association rule includes a range of concentrations for each fragrance ingredient, e.g., one or more fragrance ingredients, contained in the association rule. In some embodiments, the concentration range for a fragrance ingredient included in an association rule may be averaged to calculate a mean concentration. Thus, in some embodiments, the association rule includes the mean (average) concentration for each fragrance ingredient included in an association rule. In some embodiments, the association rule includes a median concentration for each fragrance ingredient included in an association rule.

In some embodiments, the concentrations of two or more fragrance ingredients included in an association rule may be expressed as a ratio. In some embodiments, if the concentration of each fragrance ingredient included in an association rule is expressed as a range, the ratio of the fragrance ingredients may be expressed as a range of ratios. In some embodiments, if the concentration of each fragrance ingredient included in an association rule is expressed as a range, the ratio of the fragrance ingredients may be expressed as the ratio of the mean (average) concentrations of each fragrance ingredient. In some embodiments, if the concentration of each fragrance ingredient included in an association rule is expressed as a range, the ratio of the fragrance ingredients may be expressed as the ratio of the median concentrations of each fragrance ingredient.

Any means of expressing a fragrance ingredient concentration may be used in accordance with the methods, including the association rule mining methods, described herein. In some embodiments, a concentration of a fragrance ingredient may be expressed as a percentage (e.g., a percent weight), a fraction, or a proportion (e.g., parts per 1000, parts per million (ppm), parts per billion (ppb), parts per trillion (ppt)). In some embodiments, the concentration is expressed as a relationship between fragrance ingredients in a composition. In some embodiments, the concentration is expressed as a ratio of fragrance ingredients.

In some embodiments, the one or more association rules may be evaluated for quality, for example as described in Section I-B. In some embodiments, the quality of the association rule is determined based on one or more of a level of support, a level of confidence, or a level of lift, e.g., as described in Sections I-B-1 to I-B-3 below. In some embodiments, the quality of the association rule is determined based on a level of support and a level of lift. In some embodiments, the level of support, level of confidence, and/or level of lift must meet or exceed a predefined minimum threshold for the association rule to be considered valid.

It should be appreciated that the methods provided herein may be used to generate association rules applicable to a global population and/or association rules applicable to a particular demographic. In some embodiments, the one or more association rules are generalizable across demographic groups, e.g., across populations in multiple countries, across ethnicities, across age groups, across genders, etc. In some embodiments, the association rules generated are specific to a demographic group, e.g., a population in a particular country, an ethnicity, an age group, a gender, etc. In some embodiments, the one or more association rules are specific to France, China, United Kingdom, USA, Brazil, Germany, India, Indonesia, Mexico, Japan, or Vietnam. In some embodiments, the one or more association rules are generalizable across age groups. In some embodiments, the one or more association rules generated are specific to an age group. In some embodiments, the creation of demographic-specific association rules is accomplished according to the methods described in Section I-C. The ability to generate association rules applicable globally or to a demographic may allow for the selective production of fragrance compositions, e.g., new fragrance composition and/or modified fragrance compositions, applicable to global or specific demographics.

Association rules determined according to the methods herein may be stored in a database, such as a database described in Section I-D. It should further be appreciated that the methods herein include systems, e.g., computing systems, to perform the methods for generating, storing, and/or retrieving association rules. See, Section I-E. In some embodiments, the methods provided herein include computer-implemented methods. In some embodiments, the association rule mining methods described herein include computer-implemented methods. The methods and systems provided herein may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices. The methods and systems may take the form of web-implemented computer software. In some embodiments, the methods and systems may be implemented on a remote server.

The methods of producing a fragrance composition include the use of fragrance ingredients and/or fragrance ingredient combinations at particular concentrations determined by association rule mining to formulate the fragrance composition. In some cases, the fragrance composition is a new fragrance composition. For example, a new fragrance composition may be formulated in accordance with one or more association rules to elicit a target emotional and/or cognitive response. In some embodiments, the fragrance composition is an existing fragrance composition. In this case, the existing fragrance composition may be reformulated in accordance with one or more association rules to newly elicit or enhance a desired emotional and/or cognitive response. See, e.g., Section II.

In some embodiments, the method of producing a fragrance composition produces a new fragrance composition. In some embodiments, the association rules are used to produce a new fragrance composition. In some embodiments, the association rules are used to produce a new fragrance that elicits one or more target emotional and/or cognitive responses. In some embodiments, producing the fragrance composition includes using association rule mining described herein to identify fragrance ingredient concentrations and/or combinations of fragrance ingredient concentrations that elicit the target emotional and/or cognitive response that can be formulated into the new fragrance composition. In some embodiments, producing the fragrance composition includes querying a database containing association rules to identify fragrance ingredient concentrations and/or combinations of fragrance ingredient concentration that elicit the target emotional and/or cognitive response that can be formulated into the new fragrance composition.

In some embodiments, the method of producing a fragrance composition produces a fragrance composition that is a modification of an existing fragrance composition. In some embodiments, the association rules are used to modify an existing fragrance to elicit one or more target emotional and/or cognitive responses. In some embodiments, the association rules are used to modify an existing fragrance to enhance one or more target emotional and/or cognitive responses that the existing fragrance composition elicits. In some embodiments, producing the fragrance composition includes modifying the concentration of fragrance ingredients already present in the existing fragrance composition to align with an association rule. In some embodiments, producing the fragrance composition includes modifying the fragrance ingredients present in the existing fragrance to change the concentration and/or ratio of the fragrance ingredients to achieve the target emotional or cognitive response. In some embodiments, the modification includes one or more of increasing a concentration of an existing fragrance ingredient, decreasing a concentration of an existing fragrance ingredient, or removing an existing fragrance ingredient from the existing fragrance composition. In some embodiments, producing the fragrance composition includes modifying the existing fragrance composition by adding a new fragrance ingredient to the existing fragrance composition. In some embodiments, producing the fragrance composition includes modifying the existing fragrance composition by adding a new fragrance ingredient to the existing fragrance composition and modifying the existing fragrance ingredients. In some embodiments, producing the fragrance composition includes modifying an existing fragrance by adding a new fragrance ingredient, removing an existing fragrance ingredient, increasing a concentration of an existing fragrance ingredient, decreasing a concentration of an existing fragrance ingredient, or any combination thereof.

In some embodiments, producing the fragrance composition includes iteratively optimizing the fragrance composition. For example, the fragrance composition, either new or modified, may undergo one or more optimization procedures during which an additional association rule is incorporated into the fragrance composition. In some embodiments, at least 1, 2, 3, 4, 5 or more rounds of optimization are performed. In some embodiments, two or more rounds of optimization are performed. In some embodiments, a consumer test of the fragrance composition may be performed after one or more rounds of optimization.

### A. Fragrance Datasets

The methods for producing a fragrance composition that elicits a mental response may include the use of data derived from consumer testing. In some embodiments, the association rule mining methods provided herein may be performed using data from consumer testing. Any type or combination of consumer testing may be used provided the test involves determining an emotional or cognitive response elicited in a subject upon exposure to a fragrance, where the composition of the fragrance, e.g., concentration of fragrance ingredients, is known or quantifiable. In some embodiments, the fragrance used for consumer testing is a fragrance ingredient, an accord, a schema, or a fully formulated fragrance. The fragrance used in consumer testing may also be referred to herein as a test fragrance. In some embodiments, the association rule mining methods are performed on consumer test data including an emotional and/or cognitive response elicited in a subject from exposure to a fragrance and a concentration for each fragrance ingredient contained in the test fragrance. In the case of testing a fragrance ingredient, there is only one concentration.

A dataset including one or more emotional and/or cognitive responses elicited in a subject upon exposure to a fragrance and a concentration for each fragrance ingredient contained in the fragrance is referred to herein as a “fragrance dataset.” In some embodiments, the methods provided herein are performed using a plurality of fragrance datasets.

In some embodiments, the consumer test is a declarative test. In some embodiments, the consumer test is a free sorting test. Free sorting tests include a blind sniff test protocol in which subjects have to smell fragrances and group them based on their olfactory proximities. In some embodiments, the consumer test is a monadic test. A monadic test allows the subject to smell and evaluate a single fragrance, e.g., without a step of sorting based on olfactory properties. The testers may be requested to evaluate the fragrance, e.g., fragrance group or individual fragrance, using a descriptor. In some embodiments, the descriptor is provided as part of the consumer test.

In some embodiments, the descriptor is one or more of fresh, sensual, natural, feminine, sophisticated, caring, clean, energizing, happy, and relaxing. In some embodiments, the descriptor is one or more of healthy, soft, or memorable. In some embodiments, the descriptor is a proposition. In some embodiments, the proposition is one or more of “it provides simple cleaning,” “it cleans very effectively,” “it fights and prevents malodors,” “it provides a soft cleaning,” “it has sanitizing properties,” “it provides reassuring freshness,” “it facilitates the cleaning process,” “it boosts my energy,” “it provides protection,” “it is harmless and good for my health,” “it nourishes and moisturizes,” “it takes care of me and helps me to unwind,” “it helps me to look beautiful,” “it helps me to feel beautiful,” “it is authentic, like the real thing,” “it is unique and upscale,” “it enhances my mood and makes me feel good,” “it makes me feel good,” “it delights my senses,” “it transports me to a place I love,” “it connects me with nature,” “it helps me feel well groomed,” “I like it,” it helps me feel unique and stand out,” “it helps me to look sophisticated and seductive,” “it makes me sensual and feminine,” “it makes me feel fresh and in a good mood,” “a tasteful mark of respect that pleases others,” “it enhances my femininity and makes me feel more self-confident,” “it makes me feel charming, seductive, and elegant,” “it makes me feel sexy, attractive, and appealing,” “it calls attention,” “it makes me feel good and in a better mood,” “it makes me feel comfortable, safe, and reassured,” or “it makes me feel fresh and clean.” In some embodiments, the descriptor is a color, e.g., purple, blue, green, red, orange, yellow, indigo, violet, brown, black, white, etc. In some embodiments, the descriptor is a sound, e.g., music, or imagery, e.g., a visual scene or mental (imagined) scene. In some embodiments, the descriptor is provided to the tester in the form of a questionnaire. In some embodiments, the descriptors may be scored on a point scale, e.g., a 5 point or 10 point scale. In some embodiments, the descriptors may be scored using a binary measure. For example, in this case, the questionnaire may request that the tester choose all descriptors that apply.

In some embodiments, an emotional and/or cognitive response includes or is a descriptor described herein. In some embodiments, an emotional or cognitive response captures a general principle of the descriptor. For example, a proposition descriptor may capture a more general sense of, e.g., happiness, sexiness, confidence, cleanliness, etc. The descriptor may encompass more than one general sense. Thus, it will be appreciated that descriptors may correlate with one another. In some embodiments, emotional and/or cognitive responses are correlated with one another. In some embodiments, the test fragrance elicits correlated mental responses in a subject from exposure to the fragrance. In some embodiments, the correlation of descriptors is captured in two or more association rules, where each association rule includes the same fragrance ingredient concentration or combination of fragrance ingredient concentrations and a mental response that differs from every other rule. In some embodiments, the fragrance composition produced to elicit a target emotional and/cognitive response may further elicit emotional and/or cognitive responses correlated with the target emotional and/or cognitive response.

In some embodiments, the emotional and/or cognitive response elicited in a subject from exposure to a fragrance includes or is a descriptor described herein that the subject uses to describe the fragrance or set of grouped fragrances. In some embodiments, a fragrance dataset includes a concentration of fragrance ingredients contained in a test fragrance and one or more emotional or cognitive responses, e.g., descriptors, self-reported by the subject upon exposure to the test fragrance.

In some embodiments, the consumer test is a physiological-based test. For example, the consumer test may assess a pattern of evoked brain activity, a facial expression, a heart rate, a blood pressure, a skin conductance, a muscle tension, a startle reflex, a skin temperature, an eye movement, and/or a pupil diameter in a subject from exposure to a test fragrance. In some embodiments, a pattern of evoked brain activity in a subject from exposure to a fragrance is determined. In this case, the evoked brain activity may be analyzed to determine whether the fragrance-evoked brain activity is related to brain activity of an emotional or cognitive state. In some embodiments, the brain activity (e.g., brain activity of emotion or cognitive state, fragrance-evoked brain activity) is determined using functional neuroimaging techniques. Non-limiting examples of neuroimaging techniques include functional magnetic resonance imaging (fMRI), electroencephalography (EEG), magnetoencephalography (MEG), positron emission tomography (PET), functional near-infrared spectroscopy (fNIRS), single-photon emission computed tomography (SPECT), and functional ultrasound imaging (fUS). In some embodiments, the emotional or cognitive state includes or is attention, self-esteem, mindfulness, memory, happiness, relaxation, seduction, and energy. In some embodiments, the emotional and/or cognitive response includes or is attention, self-esteem, mindfulness, memory, happiness, relaxation, seduction, or energy.

In some embodiments, the consumer test includes a declarative test. In some embodiments, the consumer test includes a physiological-based test. In some embodiments, the consumer test includes a declarative test and a physiological based test. In some embodiments, a subject is tested using a declarative test. In some embodiments, a subject is tested using a physiological-based test. In some embodiments, a subject is tested using a declarative test and a physiological-based test. For example, the same subject may undergo both declarative and physiological-based testing. In some embodiments, a subject is tested using one of a declarative test or a physiological-based test. For example, the subject may undergo only one of a declarative or physiological-based test.

In some embodiments, the plurality of fragrance datasets includes fragrance datasets from declarative testing. In some embodiments, the plurality of fragrance datasets includes fragrance datasets from physiological-based testing. In some embodiments, the plurality of fragrance datasets includes fragrance datasets from declarative testing and physiological-based testing.

### B. Evaluation of Association Rules

Association rules determined according to the methods provided herein may be evaluated to determine the quality of the rule prior to acceptance of the rule as valid. Methods of evaluating association rule quality include, but are not limited to, determining a level of support, a level of confidence, and/or a level of lift. Each type of evaluation offers a different means of assessing the validity and value of the association rule. In some embodiments, the method for evaluating the quality of the association rule may itself be subjected to testing for robustness and/or reliability. For example, as described in Section I-B-3, a level of lift may be statistically assessed for robustness.

In some embodiments, an association rule that satisfies one or more of a level of support, a level of confidence, or a level of lift is considered valid. In some embodiments, an association rule that satisfies a level of support and a level of confidence is considered valid. In some embodiments, an association rule that satisfies a level of support and a level of lift is considered valid. In some embodiments, a valid rule is stored in a database, e.g., as described in Section I-D.

### 1. Support

Support is an indicator of how frequently a set of items (an itemset) appears in a dataset. For example, for a set T of all possible observations, a given itemset X, has support supp (X) defined by the following equation:

$$supp ( X ) = \frac{\vert t ∈ 𝒯 ; X ⊆ t \vert}{\vert T \vert} . \qquad ( 1 )$$

In some embodiments, a minimum level of support may be defined to ensure that itemsets on which an association rule may be generated occur with at least a minimum frequency in the dataset. Since the identification of frequent itemsets is a first step in the association rule mining algorithm, this first step may serve as the first means of determining a quality of an association rule.

In some embodiments, determining the quality of the association rule includes identifying if the frequency of a fragrance ingredient concentration in the plurality of fragrance datasets satisfies a minimum level of support. In some embodiments, determining the quality of the association rule includes identifying if the frequency of co-occurring fragrance ingredient concentrations in the plurality of fragrance datasets satisfies a minimum level of support. The minimum level of support may be selected by a user. In some embodiments, the minimum level of support is at least 5%, 10%, 15%, 20%, 30%, 40%, 50%, 60%, 70%, 80%, 90%, or 95%. In some embodiments, the minimum level of support is at least 5%, 10%, 15%, 20%, 25%, or 30%. In some embodiments, for example when a strategy is used to identify frequent n-dimensional, e.g., 2-dimensional, itemsets that first identifies frequent 1-dimensional itemsets the minimum level of support for each 1-dimensional item is at least 5%, 10%, 15%, 20%, or 25%. In some embodiments, the minimum level of support for each 1-dimension itemset is or is at least 5%. In some embodiments, the minimum level of support for each 1-dimension itemset is or is at least 10%. In some embodiments, the minimum level of support is set prior to the identifying of a frequent fragrance ingredient concentrations and/or frequent co-occurring fragrance ingredient concentrations in the plurality of fragrance datasets such that only fragrance ingredient concentrations and frequent co-occurring fragrance ingredient concentrations that satisfy the minimum level of support are used to determine an association rule.

### 2. Confidence

An association rule may be expressed in the form of X⇒Y, where X⊆I, Y⊆I and X∩Y=Ø. The confidence of an association rule is the conditional probability that Y (the consequent, e.g., an emotional and/or cognitive response) is true give the antecedent X (e.g., a fragrance ingredient concentration or combination of concentrations). For example, the level of confidence of an association rule X⇒Y, may be determined according to following:

$$conf ( X Y ) = \frac{supp ( X ⋃ Y )}{supp ( X )} \qquad ( 2 )$$

where supp (X U Y) is the support of the intersection of the items.

In some embodiments, determining the quality of the association rule includes determining a level of confidence for the association rule and assessing whether the level of confidence satisfies a minimum level of confidence. As with the minimum level of support, an appropriate minimum level of confidence may be selected by a user. In some embodiments, the minimum level of confidence is at least 50%, 60%, 70%, 80%, 90%, or 95%. In some embodiments, the minimum level of confidence is at least 80%, 90%, or 95%.

### 3. Lift

A lift of an association rule (e.g., X⇒Y) is the measure of the deviation of the consequent (Y, e.g., an emotional and/or cognitive response) likelihood given the antecedent (X, e.g., a fragrance ingredient concentration or combination of concentrations) from the likelihood under the assumption of independence, which may be expressed as:

$$lift ( X Y ) = \frac{conf ( X Y )}{supp ( Y )} = \frac{supp ( X ⋃ Y )}{supp ( X ) \times supp ( Y )} .$$

In some embodiments, the level of lift can be used to determine the directionality of an association rule, e.g., whether the fragrance ingredient concentration or the combination of fragrance ingredient combinations are independent, beneficial, or detrimental to eliciting an emotional and/or cognitive response. For example, if an association rule has a level of lift of 1, it would imply that the probability of occurrence of the antecedent and of the consequent are independent of one another, e.g., no rule can be drawn involving the itemset. A level of lift that is greater than 1 indicates the degree to which the occurrences are dependent on one another, while a level of lift that is less than 1 indicates that the presence of one item may have a negative effect on the presence of the other item and vice versa. In some embodiments, a minimum level of lift of greater than 1 may be selected by a user to identify rules including fragrance ingredients having a positive dependence on each other. It should be appreciated that other levels of lift, e.g., levels of lift equal to 1 or less than 1, may be selected by a user to assess other relationships, e.g., independence or negative interactions, of a fragrance ingredient and/or between fragrance ingredient combinations. These association rules may also be stored in a database as described herein.

In some embodiments, determining the quality of the association rule includes determining a level of lift for the association rule and assessing whether the level of lift satisfies a minimum level of lift. In some embodiments, the minimum level of lift is at least 1.05, 1.1, 1.12, 1.13, 1.14, 1.15, 1.16, 1.17, 1.18, 1.19, or 1.2. In some embodiments, the minimum level of lift is or is at least 1.1. In some embodiments, the minimum level of lift is or is at least 1.2.

In some embodiments, the level of lift of an association rule is evaluated for robustness. In some embodiments, the level of lift must satisfy a minimum level of lift and be robust. In some embodiments, the robustness indicates the reliability of the computed level of lift for the association rule.

In some embodiments, the level of lift is evaluated for robustness using a non-parametric test. Any non-parametric test suitable for evaluating the level of lift known in the art may be used to assess robustness. In some embodiments, the non-parametric test is a permutation test. For purposes of determining the robustness of the level of lift for a specific association rule, an objective may be to verify whether by permuting results for all association rules having the same consequent, i.e., a mental response, the level of lift (e.g., theoretical lift) will remain unchanged compared to the level of lift computed for the specific association rule. Therefore, under the null hypothesis, the theoretical lift and the computed level of lift will be or be about equal.

In some embodiments, the permutation test is performed for a given association rule by calculating a level of lift for each permutation and returning a p-value as the number of times the observed level of lift is larger than the computed level of lift for the association rule divided by the number of permutations. In some embodiments, the number of permutations is or is at least 5000 or 10,000. Selecting a suitable number of permutations that satisfy statistical needs and optimizes computation resources is known in the art. In some embodiments, association rules having a p-value less than or equal to alpha are considered robust. In some embodiments, alpha is equal to or less than 0.1, 0.05, or 0.01. In some embodiments, alpha is 0.1. In some embodiments, the level of lift of an association rule must satisfy a minimum level of lift and have a p-value of equal to or less than 0.01, 0.05, or 0.1 when tested for robustness according a permutation test. In some embodiments, the level of lift of an association rule must satisfy a minimum level of lift and have a p-value of less than 0.1 when tested for robustness according a permutation test.

In some embodiments, for example when the association rule corresponds to a combination of fragrance ingredients at specific concentrations, the contribution of a fragrance ingredient to the level of lift of the association rule may be determined. The contribution of the fragrance ingredient to the level of lift may be defined as the deviation of the level of lift with the fragrance ingredient from the level of lift determined without the ingredient, and thus provides an estimate of the participation of the fragrance ingredient to the association rule. In some embodiments, the contribution of the fragrance ingredient to the level of lift is determined by subtracting the level of lift for a 1-dimensional fragrance ingredient from the level of lift determined for the same fragrance ingredient in combination with one or more fragrance ingredients. In some embodiments, the contribution of a fragrance ingredient to an association rule is stored, e.g., in a database, along with the association rule. In some embodiments, the contribution of a fragrance ingredient to an association rule is used to formulate a fragrance composition.

### C. Global and Demographic-Specific Association Rules

Any demographic of interest may undergo consumer testing as described herein to generate fragrance datasets for use according to the methods provided herein. In some embodiments, the consumer testing is conducted with different ethnic groups, different age groups, different genders, etc. In some embodiments, the consumer testing is conducted in different countries. In some embodiments, the consumer testing is conducted on different age groups. In some embodiments, the consumer testing is conducted on different genders. It is also possible to generate fragrance datasets for use according to the methods provided herein without specifically testing a demographic group of interest. The methods provided herein allow for fragrance datasets generated from any consumer test to be pooled such that the methods of association rule mining described herein can be performed on the pooled fragrance datasets. In this way, the association rule mining methods described herein can identify association rules applicable to a global population. Alternatively, the fragrance datasets may be sorted to produce fragrance datasets applicable to a demographic group of interest. In this case, the association rule mining methods described herein can identify association rules applicable to a demographic group.

Association rules determined according to the methods described herein may result in a plurality of association rules having different antecedents (e.g., fragrance ingredient concentrations, combinations of fragrance ingredient concentrations), but which elicit the same emotional and/or cognitive response (consequent). This situation may arise due to differences in fragrances tested across consumer studies. Thus, to uniformly assess association rules, a process of reapplication may be performed. The process of reapplication may be performed by identifying an association rule applicable either globally or to a demographic group and assessing whether the association rule is present in a different group of fragrance datasets, e.g., from new consumer testing. In some embodiments, an association rule applicable to a global population may be reapplied to a specific demographic group. In some embodiments, an association rule applicable to a demographic group may be reapplied to a different demographic group or to the pooled fragrance datasets (global). In some embodiments, the reapplication process includes identifying fragrance ingredient concentrations and/or combinations of fragrance ingredient concentrations of the existing association rule in the different group of fragrance datasets and calculating a level of lift for an emotional and/or cognitive response. In some embodiments, the reapplication process produces association rules in the different group of fragrance datasets having the same antecedents and consequences as the original reapplied association rule and further includes a level of lift for each association rule. In some embodiments, the association rules determined using reapplication are evaluated as described for any other association rule. In some embodiments, the association rules determined using reapplication may be stored in a database.

### D. Databases

Association rules identified according to the methods provided herein may be stored in a database. In some embodiments, the database is configured to store a plurality of association rules using a suitable data storage format and schema. In some embodiments, association rules applicable to a demographic group are stored in a database. In some embodiments, association rules applicable to a global population are stored in a database. In some embodiments, association rules that are applicable to a demographic group and association rules applicable to a global population are stored in a database.

The databases may be manipulatable and/or searchable. For example, the database may include a query module that allows the storage, identification, modification, updating, accessing, etc. of association rules stored therein. In some embodiments, a user interface may be used to query the database. For example, the database may be queried to extract all information relating to a particular emotional and/or cognitive response, demographic group (e.g., country, age, gender, ethnicity), and/or fragrance ingredient. In some embodiments, the database may be queried to provide association rules for an emotional and/or cognitive response applicable to an existing fragrance. For example, information about an existing fragrance formulation may be used as input to identify useful association rules, e.g., to elicit a target emotional and/or cognitive response. In some embodiments, information about an existing fragrance formulation may be used as input to identify association rules present in the fragrance to predict the emotional and/or cognitive states elicited by the existing fragrance.

In some embodiments, the database may include information about the fragrance ingredients, e.g., chemical structure, regulatory information, etc., in addition to association rules relevant to the fragrance ingredient.

### E. Systems

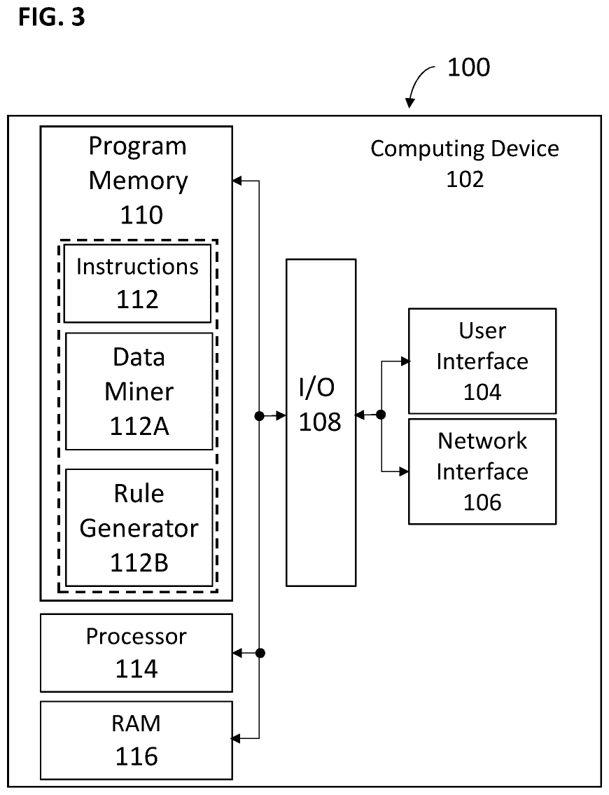

While the methods provided herein are not dependent on a particular system, systems for use in the context of the method may have one or more of the features described herein. FIG. 3 shows an exemplary system (100) for performing the method as described herein, specifically a method for identifying fragrance ingredients and combinations that elicit an emotional and/or cognitive response in a subject. It will be understood that each block of the block diagrams and flowchart illustrations (e.g., FIGS. 1-3), and combinations of blocks in the block diagrams and flowchart illustrations, respectively, may be implemented by computer program instructions. These computer program instructions may be loaded onto a general purpose computer, special purpose computer, or other programmable data processing apparatus (e.g., a remote server) to produce a machine, such that the instructions which execute on the computer or other programmable data processing apparatus create a means for implementing the functions specified in the flowchart block or blocks.

In the illustrated embodiment of FIG. 3, the system (100) may include a computing device (102) which may be, for example, a computer, a hand held device, a plurality of networked computing devices, a plurality of cloud computing devices, a remote server, etc. Accordingly, for ease of discussion only and not for limitation purposes, the computing device (102) is referred to herein using the singular tense, although in some embodiments the computing device (102) may include more than one physical device. In some embodiment, the computing device (102) may be physically located with the individual performing the method. In some embodiments, the computing device (102) may be remotely accessible. In some embodiments, the computing device (102) may be a web server that is remotely located from the individual performing the method. The computing device (102) may include at least one processor (e.g., a controller, a microcontroller, or a microprocessor) (114), a random-access memory (RAM) (116), a user interface (104), a network interface (106), a program memory (110) and an input/output (I/O) circuit (108), each of which may be interconnected via an address/data bus. In some embodiments, the user interface (104) may include a display and input devices including a keyboard and/or a mouse. In some embodiments, the program memory (110) includes at least one tangible, non-transitory computer readable storage medium or device. The at least one tangible, non-transitory computer readable storage medium or device may be configured to store computer-executable instructions (112) that, when executed by the at least one processor (114), cause the computing device (102) to implement a method, e.g., (10), (12), described herein.

In some embodiments, the instructions (112) include computer-executable steps for performing association rule mining as described herein. In some embodiments, the instructions (112) include a data miner (112A) for identifying frequent fragrance ingredients and/or frequent co-occurring fragrance ingredients, e.g., in a fragrance dataset. The data miner may be configured to mine information stored on a computer network such as the internet, an intranet, a server farm, a personal computer, etc. In some embodiments, the instructions include a rule generator (112B) for determining one or more association rules from the frequent fragrance ingredients and/or co-occurring fragrance ingredients. One or more other sets of computer-executable instructions (112) may be executable by the processor (114). In some embodiments, the one or more other sets of computer-executable instructions (112) may be executable by the processor (114) for causing the system (100) to evaluate the one or more association rules, store the one or more association rules in a database, and/or query the database.

In some embodiments, the instructions stored in the computer readable storage medium produce an article of manufacture including computer-readable instructions for implementing the association rule mining methods provided herein. The instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the association rule mining methods described herein.

### II. FRAGRANCE INGREDIENTS AND FRAGRANCE COMPOSITIONS THAT ELICIT AN EMOTIONAL AND/OR COGNITIVE RESPONSE

Also provided herein are fragrance ingredients, fragrance ingredient combinations, fully formulated fragrances, and accords that elicit one or more emotional and/or cognitive responses in a subject determined according to the methods described herein.

The association rules generated according to the methods described herein offer the unique ability to swiftly and strategically produce fragrance compositions having the ability to elicit an emotional and/or cognitive response in a subject. The association rules may serve as a guide for fragrance composition development. Thus, also provided herein are fragrance compositions that incorporate the association rules generated according to the methods provided herein. In some embodiments, the fragrance compositions are designed specifically to elicit one or more emotional and/or cognitive responses in a subject.

In some embodiments, the fragrance composition is a new fragrance composition. In some embodiments, the association rules are used to develop a new fragrance composition. For example, an objective may be to produce a fragrance composition that elicits an emotional and/or cognitive response in a subject upon exposure. In this case, it would be possible to query a database containing association rules to identify fragrance ingredient combinations on which to formulate the fragrance composition. Furthermore, it may be possible to refine the query to identify association rules applicable to a global population or a demographic group.

In some embodiments, the fragrance composition is an existing fragrance composition in which the concentration of fragrance ingredients already present in the composition have been modified to align with an association rule. For example, it may be desirable to incorporate an ability to elicit a target emotional and/or cognitive response in a subject in an existing fragrance composition without adding new fragrance ingredients to the fragrance composition. In this case, it would be possible to query a database containing association rules using the fragrance composition formulation (e.g., concentrations of fragrance ingredients contained in the fragrance composition) as input and restricting the query to identify association rules containing the existing fragrance ingredients. In some embodiments, the query may also include a target emotional and/or cognitive response to be incorporated into the fragrance composition. In some embodiments, the query may further include a restriction to identify association rules applicable to a global population or a demographic group. In this example, the existing fragrance composition may then be modified to change the concentration or ratio of existing ingredients to achieve the desired emotional or cognitive response. In some embodiments, the modification includes one or more of increasing a concentration of an existing fragrance ingredient, decreasing a concentration of an existing fragrance ingredient, or removing an existing fragrance ingredient from the existing fragrance composition.

In some embodiments, the fragrance composition is an existing fragrance composition in which a fragrance ingredient not present in the existing fragrance composition is added to incorporate an association rule. For example, it may be desirable to incorporate an association rule into an existing fragrance without manipulating the concentrations or ratios of the existing fragrance composition. In order to accomplish this, it would be necessary to add a new fragrance ingredient to the existing composition. In this case, it would be possible to query a database containing association rules using the fragrance composition formulation (e.g., concentrations of fragrance ingredients contained in the fragrance composition) as input and restricting the query to identify association rules containing at least one fragrance ingredient not present in the existing formula.

In some embodiments, the query may also include a target emotional and/or cognitive response to be incorporated into the fragrance composition. In some embodiments, the query may further include a restriction to identify association rules applicable to a global population or a demographic group. In this example, the existing fragrance composition may then be modified such that the concentration or ratio of existing fragrance ingredients is maintained and a new fragrance ingredient is added to achieve the target emotional and/or cognitive response.

In some embodiments, the fragrance composition is an existing fragrance composition in which a fragrance ingredient not present in the existing fragrance composition is added and an existing fragrance ingredient is modified (e.g., concentration increased or decreased) to incorporate an association rule. For example, it may be desirable to identify relationships between fragrance ingredients present in the fragrance composition and new fragrance ingredients to explore ways to modify the existing fragrance composition. In this case, it would be possible to query a database containing association rules using the fragrance composition formulation (e.g., concentrations of fragrance ingredients contained in the fragrance composition) as input and restricting the query to identify association rules containing at least one fragrance ingredient present in the existing formula. In some embodiments, the query may also include a target emotional and/or cognitive response to be incorporated into the fragrance composition. In some embodiments, the query may further include a restriction to identify association rules applicable to a global population or a demographic group. In this example, the existing fragrance composition may be modified such that the concentration of an existing fragrance ingredient is maintained, increased, or decreased and a new fragrance ingredient is added to achieve the target emotional and/or cognitive response. In some embodiments, the fragrance composition is a fragrance ingredient combination. In some embodiments, the fragrance composition is a fully formulated fragrance. In some embodiments, the fragrance composition is an accord. In some embodiments, the fragrance composition is a schema. In some embodiments, the fragrance composition is a flanker.

The fragrance compositions and fragrance ingredients provided herein are widely applicable to any perfumery product, including perfumes and colognes, the perfuming of personal care products such as soaps, shower gels, and hair care products, fabric care products, air fresheners, and cosmetic preparations. In some embodiments, the fragrance composition is used to perfume cleaning agents, such as, but not limited to, detergents, dishwashing materials, scrubbing compositions, window cleaners and the like. In these preparations, the fragrance compositions can be used alone or in combination with other perfuming compositions, solvents, adjuvants and the like. The nature and variety of the other ingredients that can also be employed are known to those with skill in the art. Many types of additional fragrances can be employed so long as the fragrance is complementary (i.e., compatible) with the other components being employed.

The fragrance compositions and fragrance ingredients provided herein may be well-suited for use in a variety of consumer products and can be used as a neat fragrance formulation (e.g., in a fine fragrance) or may be encapsulated and/or delivered using a suitable carrier material. Some well-known materials include, for example, polymers, oligomers, other non-polymers such as surfactants, emulsifiers, lipids including fats, waxes and phospholipids, organic oils, mineral oils, petrolatum, natural oils, perfume fixatives, fibers, starches, sugars and solid surface materials such as zeolite and silica.

In addition to the fragrance composition itself, also provided are consumer products containing the fragrance composition. Consumer products may include, for example, perfumes, colognes, bar soaps, liquid soaps, shower gels, foam baths, cosmetics, skin care products such as creams, lotions and shaving products, hair care products for shampooing, rinsing, conditioning, bleaching, coloring, dyeing and styling, deodorants and antiperspirants, feminine care products such as tampons and feminine napkins, baby care products such as diapers, bibs and wipes, family care products such as bath tissues, facial tissues, paper handkerchiefs or paper towels, fabric products such as fabric softeners and fresheners, air care products such as air fresheners and fragrance delivery systems, cosmetic preparations, cleaning agents and disinfectants such as detergents, dishwashing materials, scrubbing compositions, glass and metal cleaners such as window cleaners, countertop cleaners, floor and carpet cleaners, toilet cleaners and bleach additives, washing agents such as all-purpose, heavy duty, and hand washing or fine fabric washing agents including laundry detergents and rinse additives, dental and oral hygiene products such as toothpastes, tooth gels, dental flosses, denture cleansers, denture adhesives, dentifrices, tooth whitening and mouthwashes, health care and nutritional products and food products such as snack and beverage products.

### III. EXEMPLARY EMBODIMENTS

### Among the Provided Embodiments are:

1. A method for producing a fragrance composition that elicits an emotional and/or cognitive response in a subject, the method comprising: (a) selecting one or more target emotional and/or cognitive responses to be elicited by a fragrance composition; (b) identifying in a plurality of association rules one or more fragrance ingredients and/or one or more combinations of fragrance ingredients that elicit the one or more target emotional and/or cognitive responses, wherein each association rule corresponds to a fragrance ingredient concentration or a combination of fragrance ingredient concentrations that elicits an emotional and/or cognitive response in a subject; and (c) formulating into the fragrance composition the one or more fragrance ingredients and/or one or more combinations of fragrance ingredients at concentrations that elicit the one or more target emotional and/or cognitive responses.

2. The method of embodiment 1, wherein the plurality of association rules are generated by: (a) identifying in a plurality of fragrance datasets a frequent fragrance ingredient concentration and/or frequent co-occurring fragrance ingredient concentrations, wherein each of the plurality of fragrance datasets comprises an emotional and/or cognitive response elicited in a subject from an exposure to a fragrance and a concentration for each of one or more fragrance ingredients comprised in the fragrance; and (b) determining based on the frequent fragrance ingredient concentration and/or the frequent co-occurring fragrance ingredient concentrations the plurality of association rules.

3. The method of embodiment 1 or embodiment 2, wherein the fragrance composition that elicits the one or more target emotional and/or cognitive responses is applicable to a global population.

4. The method of embodiment 1 or embodiment 2, wherein the fragrance composition that elicits the one or more target emotional and/or cognitive responses is applicable to a demographic group.

5. The method of any one of embodiments 1-4, wherein the fragrance composition is a new fragrance composition.

6. The method of any one of embodiments 1-4, wherein the fragrance composition is an existing fragrance composition that has been modified.

7. The method of any one of embodiments 1-4 and 6, wherein the fragrance composition is an existing fragrance composition that has been modified by adding a new fragrance ingredient, removing an existing fragrance ingredient, increasing a concentration of an existing fragrance ingredient, decreasing a concentration of an existing fragrance ingredient, or any combination thereof.

8. The method of any one of embodiments 1-7, wherein the fragrance composition is a fully formulated fragrance or an accord.

9. The method of any one of embodiments 1-8, wherein the fragrance composition is comprised in a consumer product, optionally wherein the consumer product is a household product, a laundry product, a personal care product, a cosmetic product, or a fine fragrance.

10. The method of any one of embodiments 1-9, wherein the fragrance composition elicits an emotional and/or cognitive response that is correlated with the one or more target emotional and/or cognitive responses.

11. A method for identifying a fragrance ingredient and/or a combination of fragrance ingredients that elicit an emotional and/or cognitive response in a subject, comprising: (a) identifying in a plurality of fragrance datasets a frequent fragrance ingredient concentration and/or frequent co-occurring fragrance ingredient concentrations, wherein each of the plurality of fragrance datasets comprises an emotional and/or cognitive response elicited in a subject from an exposure to a fragrance and a concentration for each of one or more fragrance ingredients comprised in the fragrance; and (b) determining one or more association rules based on the frequent fragrance ingredient concentration and/or the frequent co-occurring fragrance ingredient concentrations, wherein each association rule corresponds to a fragrance ingredient concentration or combination of fragrance ingredient concentrations that elicits the emotional and/or cognitive response.

12. The method of any one of embodiments 2-11, wherein the plurality of fragrance datasets is produced by performing consumer testing or receiving consumer testing data.

13. The method of any one of embodiments 1-12, wherein the emotional and/or cognitive response elicited in the subject is determined using a declarative test and/or a physiological-based test.

14. The method of any one of embodiments 1-13, wherein the emotional and/or cognitive response is selected from the group consisting of caring, clean, energizing, feminine, fresh, happy, natural, relaxing, sensual, sophisticated, attention, self-esteem, mindfulness, memory, happiness, relaxation, seduction, energy, “it provides simple cleaning,” “it cleans very effectively,” “it fights and prevents malodors,” “it provides a soft cleaning,” “it has sanitizing properties,” “it provides reassuring freshness,” “it facilitates the cleaning process,” “it boosts my energy,” “it provides protection,” “it is harmless and good for my health,” “it nourishes and moisturizes,” “it takes care of me and helps me to unwind,” “it helps me to look beautiful,” “it helps me to feel beautiful,” “it is authentic, like the real thing,” “it is unique and upscale,” “it enhances my mood and makes me feel good,” “it makes me feel good,” “it delights my senses,” “it transports me to a place I love,” “it connects me with nature,” “it helps me feel well groomed,” “I like it,” it helps me feel unique and stand out,” “it helps me to look sophisticated and seductive,” “it makes me sensual and feminine,” “it makes me feel fresh and in a good mood,” “a tasteful mark of respect that pleases others,” “it enhances my femininity and makes me feel more self-confident,” “it makes me feel charming, seductive, and elegant,” “it makes me feel sexy, attractive, and appealing,” “it calls attention,” “it makes me feel good and in a better mood,” “it makes me feel comfortable, safe, and reassured,” and “it makes me feel fresh and clean.”

15. The method of any one of embodiments 1-10 and 12-14, wherein the one or more target emotional and/or the cognitive responses are selected from the group consisting of caring, clean, energizing, feminine, fresh, happy, natural, relaxing, sensual, sophisticated, attention, self-esteem, mindfulness, memory, happiness, relaxation, seduction, energy, “it provides simple cleaning,” “it cleans very effectively,” “it fights and prevents malodors,” “it provides a soft cleaning,” “it has sanitizing properties,” “it provides reassuring freshness,” “it facilitates the cleaning process,” “it boosts my energy,” “it provides protection,” “it is harmless and good for my health,” “it nourishes and moisturizes,” “it takes care of me and helps me to unwind,” “it helps me to look beautiful,” “it helps me to feel beautiful,” “it is authentic, like the real thing,” “it is unique and upscale,” “it enhances my mood and makes me feel good,” “it makes me feel good,” “it delights my senses,” “it transports me to a place I love,” “it connects me with nature,” “it helps me feel well groomed,” “I like it,” it helps me feel unique and stand out,” “it helps me to look sophisticated and seductive,” “it makes me sensual and feminine,” “it makes me feel fresh and in a good mood,” “a tasteful mark of respect that pleases others,” “it enhances my femininity and makes me feel more self-confident,” “it makes me feel charming, seductive, and elegant,” “it makes me feel sexy, attractive, and appealing,” “it calls attention,” “it makes me feel good and in a better mood,” “it makes me feel comfortable, safe, and reassured,” and “it makes me feel fresh and clean.”

16. The method of any one of embodiments 2-15, wherein the fragrance is a fragrance ingredient, an accord, a schema, or a fully formulated fragrance.

17. The method of any one of embodiments 2-16, wherein the frequent fragrance ingredient concentration and/or frequent co-occurring fragrance ingredient concentrations satisfy a minimum level of support of at least 5%.

18. The method of any one of embodiments 1-17, wherein each of the association rules satisfies a minimum level of lift of at least 1.1.

19. The method of embodiment 18, wherein the level of lift is robust according to a non-parametric test, optionally a permutation test.

20. The method of any one of embodiments 1-19, wherein the fragrance ingredient concentration and/or the combination of fragrance ingredient concentrations of the association rule is expressed as a concentration range and/or an average concentration for the fragrance ingredient or each of the fragrance ingredients in the combination, and wherein a lower bound and an upper bound of the concentration range are determined by identifying a lower most concentration and an upper most concentration of the fragrance ingredient or each of the fragrance ingredients in the combination that elicits the emotional and/or cognitive response.

21. The method any one of embodiments 1-20, wherein the combination of fragrance ingredient concentrations of the association rule is expressed as a range of ratios of the fragrance ingredients in the combination and/or an average ratio of the fragrance ingredients in the combination, and wherein a lower bound and an upper bound of the ratio range are determined by identifying a lower most concentration and an upper most concentration of each of the fragrance ingredients in the combination that elicits the emotional response or cognitive response.

22. The method of any one of embodiments 1-21, wherein each of the association rules are applicable to a global population.

23. The method of any one of embodiments 1-21, wherein each of the association rules are applicable to a demographic group.

24. The method of any one of embodiments 1-23, wherein each of the association rules are stored in a database.

25. A database comprising a plurality of association rules determined according to the method of any one of embodiments 2-24.

26. A fragrance ingredient, a fragrance ingredient combination, a fully formulated fragrance, or an accord that elicits one or more emotional and/or cognitive responses in a subject, wherein the fragrance ingredient, the fragrance ingredient combination, the fully formulated fragrance, or the accord comprises one or more fragrance ingredients or one or more combinations of fragrance ingredients determined according to the method of any one of embodiments 2-24 or the database of embodiment 25 to elicit the emotional or cognitive response.

27. A method for preparing a fully formulated fragrance or an accord that elicits an emotional or cognitive response, the method comprising: (a) identifying according to a method of any one of embodiments 11-24 or a database of embodiment 25 a fragrance ingredient or fragrance ingredient combination that elicits a target emotional and/or cognitive response; and (b) formulating into a fully formulated fragrance or an accord the fragrance ingredient or fragrance ingredient combination at concentrations that elicit the target emotional and/or cognitive response.

28. A consumer product comprising a fragrance composition produced according to a method of any one of embodiments 1-10, a fragrance ingredient, a fragrance ingredient combination, a fully formulated fragrance, or an accord according to embodiment 26, or a fully formulated fragrance or an accord prepared according to embodiment 27, wherein the consumer product is a household product, a laundry product, a personal care product, a cosmetic product, or a fine fragrance.

29. Use of a fragrance composition produced according to a method of any one of embodiments 1-10, a fragrance ingredient, a fragrance ingredient combination, a fully formulated fragrance, an accord according to embodiment 24, or a fully formulated fragrance or an accord prepared according to embodiment 27, or a consumer product according to embodiment 28 to elicit one or more emotional and/or cognitive responses in a consumer from exposure.

### IV. EXAMPLES

The following examples are included for illustrative purposes only and are not intended to limit the scope of the invention.

### Example 1: Incorporation of Association Rules into Fragrance Compositions

This Example demonstrates the use of association rules to modify existing fragrance compositions to elicit one or more emotional and/or cognitive responses.

### Methods

Central location paired comparison testing was conducted in 3 countries: USA, France, and Brazil (60 consumers per country). Pairs of fragrances specific to each country were tested. Each pair included an original fragrance formulation and a modified version of the original fragrance formulation, where the modified version incorporated one or more country-specific association rules to elicit a target mental response. The incorporated association rules were determined by mining declarative consumer test data (e.g., free sorting and/or monadic) as described herein (e.g., valid rules satisfied a level of support of at least 5%, a level of lift of at least 1.1, and the lift was determined to be robust).

Sniff tests were performed using pilulars with cotton. Consumers were asked to complete a questionnaire (5-pt scale) comparing the fragrance pairs. An exemplary question is shown below.

Exemplary methods and results specific to Brazil follow; however, similar methods and results were obtained in each test country.

Table 1 shows the original fragrance and the targeted response to incorporate for Brazil.

TABLE 1

| FRAGRANCE NAME | TARGET RESPONSE |
|---|---|
| DARK LOLA | FEEL GOOD & FRESH |
| VANITY | STAND OUT |

To increase the perception of “feel good and fresh” for fragrance DARK LOLA, existing association rules A and B were selected. For rule A, Citronellol and Eugenol were added to the original fragrance formula. To incorporate rule B, the concentration of Damascenone was maintained and the concentration of Meth ionone gamma was increased.

To increase the perception of “standout” for fragrance VANITY, existing association rules C and D were selected. For rule C, Pepper pink was added to the fragrance formulation and the concentration of citronellol was decreased. For rule D, the concentration of Muscemor and Hexenyl cis-3 acetate was increased.

### Results

To assess whether incorporation of the association rule into the fragrance increased the targeted response, each questionnaire response was divided into three categories: (1) consumers who found the modified fragrance to be “a lot less” or “a little less” than the original fragrance; (2) consumers who found the modified and original fragrance formulations to be the “same”; and (3) consumers who found the modified fragrance to be “a little more” or “a lot more” than the original fragrance. The percentage of consumers for each of the three categories for each question was determined.

As shown in Tables 2 and 3 below, for both DARK LOLA and VANITY the incorporation of the association rules resulted in a majority of consumers perceiving an increase in the target mental response compared to the original fragrance formulation.

TABLE 2
DARK LOLA

| | Group | | |
|---|---|---|---|
| Response | 1 | 2 | 3 |
| Feel Good and Fresh | 18% | 24% | 58% |
| (target) | | | |

TABLE 3
VANITY

| | Group | | |
|---|---|---|---|
| Response | 1 | 2 | 3 |
| Stand Out (target) | 25% | 18% | 57% |

In addition, increases in mental responses correlated with the target response were also observed. A similar majority of consumers reported the modified DARK LOLA fragrance as having an increase in natural, energizing, relaxing, and happy response. The modified VANITY fragrance was also reported by a similar majority of consumers to have increased sensual, seductive, and liking responses. For VANITY, an increase in fit in response was also observed likely due to a correlation with the liking response.

These data support the validity and usefulness of association rules, and further illustrate how the association rules may be used to produce fragrance compositions that influence consumer perception.

### Example 2: Incorporation of Association Rules for Clean and Upscale into Fragrance Compositions

This Example demonstrates the use of association rules to modify existing fragrance compositions to elicit “clean” or “upscale and unique” mental responses.

### Methods

Central location paired comparison testing was conducted in the UK (60 consumers). Each pair included an original fragrance formulation and a modified version of the original fragrance formulation, where the modified version incorporated country-specific association rules to elicit the target mental response. The incorporated association rules were determined by mining declarative UK consumer test data (e.g., free sorting and/or monadic) as described herein (e.g., valid rules satisfied a level of support of at least 5%, a level of lift of at least 1.1, and the lift was determined to be robust).

Tests were performed using damp towels washed with a fabric conditioner containing the fragrance composition. Consumers were asked to complete a questionnaire (5-pt scale) comparing the fragrance pairs. An exemplary question is shown below.

Table 4 shows the original fragrance and the target mental response incorporated.

TABLE 4

| FRAGRANCE NAME | TARGET RESPONSE |
|---|---|
| COMFORT GOLD | CLEAN |
| PURESSENCE | UPSCALE AND UNIQUE |

To increase the perception of “clean” for fragrance COMFORT GOLD, existing association rules A and B were selected. For rule A, Galbascone was added and the concentration of Damascenone was decreased. To incorporate rule B, Patchouli oil was added and the concentration of Citronellol was increased.

To increase the perception of “upscale and unique” for fragrance PURESSENCE, existing association rules C and D were selected. For rule C, Muscemor and Operanide were added to the original fragrance formula. To incorporate rule D, Ylanganate was added to the original fragrance formula.

### Results

To assess whether incorporation of the association rules into the fragrance increased the targeted response, each questionnaire response was divided into three categories: (1) consumers who found the modified fragrance to be “a lot less” or “a little less” than the original fragrance; (2) consumers who found the modified and original fragrance formulations to be the “same”; and (3) consumers who found the modified fragrance to be “a little more” or “a lot more” than the original fragrance. The percentage of consumers for each of the three categories for each question was determined.

As shown in Tables 5 and 6 below, for both COMFORT GOLD and PURESSENCE the incorporation of the association rules resulted in a majority of consumers perceiving an increase in the target mental response compared to the original fragrance formulation.

TABLE 5
COMFORT GOLD

| | Group | | |
|---|---|---|---|
| Response | 1 | 2 | 3 |
| Clean (target) | 31% | 13% | 56% |

TABLE 6
PURESSENCE

| | Group | | |
|---|---|---|---|
| Response | 1 | 2 | 3 |
| Upscale and Unique | 23% | 13% | 64% |
| (target) | | | |

In addition, increases in mental responses correlated with the target response were also observed. Consumers reported the modified COMFORT GOLD fragrance as having an increase in liking, protection, and fresh responses. The modified PURESSENCE fragrance was also reported by consumers to have increased liking, clean, pampering, protection, and fresh responses.

These data support the validity and usefulness of association rules not only in neat fragrances but also in consumer fragrances and products to influence consumer mental responses. These results further support the ability of the methods to elicit emotional and/or cognitive responses in a demographically specific way.

The present invention is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure. Although the invention may be described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for producing a fragrance composition that elicits an emotional and/or cognitive response in a subject, the method comprising:
(a) selecting one or more target emotional and/or cognitive responses to be elicited by a fragrance composition;
(b) identifying in a plurality of association rules one or more fragrance ingredients and/or one or more combinations of fragrance ingredients that elicit the one or more target emotional and/or cognitive responses, wherein each association rule corresponds to a fragrance ingredient concentration or a combination of fragrance ingredient concentrations that elicits an emotional and/or cognitive response in a subject; and
(c) formulating into the fragrance composition the one or more fragrance ingredients and/or one or more combinations of fragrance ingredients at concentrations that elicit the one or more target emotional and/or cognitive responses.

2. The method of claim 1, wherein the plurality of association rules is generated by:
(a) identifying in a plurality of fragrance datasets a frequent fragrance ingredient concentration and/or frequent co-occurring fragrance ingredient concentrations, wherein each of the plurality of fragrance datasets comprises an emotional and/or cognitive response elicited in a subject from an exposure to a fragrance and a concentration for each of one or more fragrance ingredients comprised in the fragrance; and
(b) determining based on the frequent fragrance ingredient concentration and/or the frequent co-occurring fragrance ingredient concentrations the plurality of association rules.

3. The method of claim 1 or claim 2, wherein the fragrance composition that elicits the one or more target emotional and/or cognitive responses is applicable to a global population.

4. The method of claim 1 or claim 2, wherein the fragrance composition that elicits the one or more target emotional and/or cognitive responses is applicable to a demographic group.

5. The method of any one of claims 1-4, wherein the fragrance composition is a new fragrance composition.

6. The method of any one of claims 1-4, wherein the fragrance composition is an existing fragrance composition.

7. The method of any one of claims 1-4 and 6, wherein the fragrance composition is an existing fragrance composition and the formulating comprises modifying the existing fragrance by adding a new fragrance ingredient, removing an existing fragrance ingredient, increasing a concentration of an existing fragrance ingredient, decreasing a concentration of an existing fragrance ingredient, or any combination thereof.

8. The method of any one of claims 1-7, wherein the fragrance composition is a fully formulated fragrance or an accord.

9. The method of any one of claims 1-8, wherein the fragrance composition is comprised in a consumer product, optionally wherein the consumer product is a household product, a fabric care product, a personal care product, a cosmetic product, or a fine fragrance.

10. The method of any one of claims 1-9, wherein the fragrance composition elicits an emotional and/or cognitive response that is correlated with the one or more target emotional and/or cognitive responses.

11. A method for identifying a fragrance ingredient and/or a combination of fragrance ingredients that elicit an emotional and/or cognitive response in a subject, comprising:
(a) identifying in a plurality of fragrance datasets a frequent fragrance ingredient concentration and/or frequent co-occurring fragrance ingredient concentrations, wherein each of the plurality of fragrance datasets comprises an emotional and/or cognitive response elicited in a subject from an exposure to a fragrance and a concentration for each of one or more fragrance ingredients comprised in the fragrance; and
(b) determining one or more association rules based on the frequent fragrance ingredient concentration and/or the frequent co-occurring fragrance ingredient concentrations, wherein each association rule corresponds to a fragrance ingredient concentration or combination of fragrance ingredient concentrations that elicits the emotional and/or cognitive response.

12. The method of any one of claims 2-11, wherein the plurality of fragrance datasets is produced by performing consumer testing or receiving consumer testing data.

13. The method of any one of claims 1-12, wherein the emotional and/or cognitive response elicited in the subject is determined using a declarative test and/or a physiological-based test.

14. The method of any one of claims 2-13, wherein the fragrance is a fragrance ingredient, an accord, a schema, or a fully formulated fragrance.

15. The method of any one of claims 2-14, wherein the frequent fragrance ingredient concentration and/or frequent co-occurring fragrance ingredient concentrations satisfy a minimum level of support of at least 5%.

16. The method of any one of claims 1-15, wherein each of the association rules satisfies a minimum level of lift of at least 1.1.

17. The method of claim 16, wherein the level of lift is robust according to a non-parametric test.

18. The method of any one of claims 1-17, wherein the fragrance ingredient concentration and/or the combination of fragrance ingredient concentrations of the association rule is expressed as a concentration range and/or an average concentration for the fragrance ingredient or each of the fragrance ingredients in the combination, and wherein a lower bound and an upper bound of the concentration range are determined by identifying a lower most concentration and an upper most concentration of the fragrance ingredient or each of the fragrance ingredients in the combination that elicits the emotional and/or cognitive response.

19. The method of any one of claims 1-18, wherein the combination of fragrance ingredient concentrations of the association rule is expressed as a range of ratios of the fragrance ingredients in the combination and/or an average ratio of the fragrance ingredients in the combination, and wherein a lower bound and an upper bound of the ratio range are determined by identifying a lower most concentration and an upper most concentration of each of the fragrance ingredients in the combination that elicits the emotional and/or cognitive response.

20. The method of any one of claims 1-19, wherein each of the association rules is applicable to a global population and/or a demographic group.

21. The method of any one of claims 1-20, wherein each of the association rules is stored in a database.

22. A database comprising a plurality of association rules determined according to the method of any one of claims 2-21.

23. A fragrance ingredient, a fragrance ingredient combination, a fully formulated fragrance, or an accord that elicits one or more emotional and/or cognitive responses in a subject, wherein the fragrance ingredient, the fragrance ingredient combination, the fully formulated fragrance, or the accord comprises one or more fragrance ingredients or one or more combinations of fragrance ingredients determined according to the method of any one of claims 2-21 or the database of claim 22 to elicit the emotional or cognitive response.

24. A method for preparing a fully formulated fragrance or an accord that elicits an emotional or cognitive response, the method comprising:
(a) identifying according to a method of any one of claims 11-21 or a database of claim 22 a fragrance ingredient or fragrance ingredient combination that elicits a target emotional and/or cognitive response; and
(b) formulating into a fully formulated fragrance or an accord the fragrance ingredient or fragrance ingredient combination at concentrations that elicit the target emotional and/or cognitive response.

25. A consumer product comprising a fragrance composition produced according to a method of any one of claims 1-10, a fragrance ingredient, a fragrance ingredient combination, a fully formulated fragrance, or an accord according to claim 23, or a fully formulated fragrance or an accord prepared according to claim 24, wherein the consumer product is a household product, a fabric care product, a personal care product, a cosmetic product, or a fine fragrance.
